(19) United States
(12) Patent Application Publication
(10) Pub. No.: US 2011/0161607 A1
(43) Pub. Date: Jun. 30, 2011

(54) STORAGE SYSTEM AND CONTROL METHOD THEREFOR

(75) Inventor: Ken Nomura, Yokohama (JP)

(73) Assignee: Hitachi ,Ltd.

(21) Appl. No.: 12/527,547

(22) PCT Filed: Apr. 14, 2009
(86) PCT No.: PCT/JP2009/001707

§ 371 Date: Aug. 17, 2009

(51) Int. Cl. G06F 12/16

(52) U.S. Cl. 711/162; 711/E12.103

(57) ABSTRACT

There is provided a storage technique for efficiently solving concentration of accesses to a particular storage medium. In the present invention, in a storage system having multiple storage media which are physically separated, duplicates of multiple blocks forming particular contents are generated, and the duplicated blocks are uniformly (in stripes) stored in storage media other than the storage medium which stores the particular contents (see FIG. 1).

### TECHNICAL FIELD

The present invention relates to a storage system and a control method therefor, and relates to, for example, a technique for distributing contents.

### BACKGROUND ART

Recently, a contents distribution system for distributing contents stored in a storage device to an unspecified large number of users has been widely used. However, as for contents like motion videos, the access frequency significantly differs among the contents, and there exist such contents that cannot be included in cache because of its too large data size. Therefore, it is difficult to reduce access concentration only by using cache.

Conventionally, as a technique for reducing access concentration, there has been a method in which a duplicated volume of a volume to which accesses are concentrated is created, and accesses to the volume are distributed to the original volume and the duplicated volume by a driver to solve the access concentration to the original volume, for example, as shown in Patent Citation 1.

### CITATION LIST

### Patent Literature

PTL 1: U.S. Pat. No. 6,961,727

### DISCLOSURE OF INVENTION

### Technical Problem

However, since the frequency of access to contents changes with time, the technique described in Patent Citation 1 still has a problem that deletion and addition of the duplicate is performed frequently as the access frequency significantly fluctuates, which causes deterioration of the system performance. Especially in an environment where there is a possibility of sudden concentration of a lot of accesses, such as an Internet environment, it is necessary to create a lot of duplicates at a time in order to cope with increase in accesses. In order to cope with such a state, the technique of Patent Citation 1 is not practical because read accesses to the original volume for duplication further increases the access traffic to the volume which already does not have sufficient capacity due to concentration of accesses.

Furthermore, in contents such as videos, the popularity degree (access frequency) significantly differs according to titles, and it is difficult to completely predict concentration of accesses to particular contents which changes with time, in advance. Therefore, there is a limit to the method of avoiding the problem by devising the operation, such as creating a duplicate in advance before occurrence of concentration of accesses.

Therefore, it is impossible to solve sudden concentration of accesses to a particular storage medium in distribution of large contents such as dynamic images by combination of conventional techniques.

The present invention has been made in view of such situation, and it provides a storage technique for efficiently solving concentration of accesses to a particular storage medium.

### Solution to Problem

In order to solve the above problem, in the present invention, in a storage system having multiple storage media which are physically separated, duplicates of multiple blocks forming particular contents are generated, and the duplicated blocks are uniformly stored in storage media other than the storage medium which stores the particular contents.

More particularly, the storage system according to the present invention is provided with multiple storage media (110 to 113), a duplication source area determination processing section (144) and a duplication processing section (144). Here, the multiple storage media (110 to 113) are multiple storage media (110 to 113) which are physically different from one another and each of which is configured by multiple blocks. The duplication source area determination processing section (144) determines duplication source areas (100 to 108) configured by multiple blocks, which are to be the duplication source, among the multiple storage media, in response to a duplication start signal. The duplication processing section (144) generates duplicates of the multiple blocks included in the duplication source areas (100 to 108), and distributes and stores the duplicates of the multiple blocks in the multiple storage media (duplication destination storage media (111 to 113)) other than the storage medium (110) which includes the duplication source areas (100 to 108).

The storage system according to the present invention is further provided with a duplication destination determination processing section (143) and a storage rule determination processing section (144). The duplication destination determination processing section (143) identifies, on the basis of specified target performance and the performance of the multiple storage media, the multiple duplication destination storage media (111 to 113) which are to be storage destinations of the duplicates of the blocks and which are required to satisfy the target performance. Furthermore, the storage rule determination processing section (144) determines a storage rule for causing the duplicates of the multiple blocks to be distributed and stored in the identified duplication destination storage media (111 to 113) in stripes. Then, in accordance with the determined storage rule, the duplication processing section (144) stores the duplicates of the multiple blocks in the identified multiple duplication destination storage media (111 to 113). This storage rule includes information indicating which block duplicate is to be stored in which duplication destination storage medium. In this case, the duplication processing section (144) may store the duplicates of blocks specified by the storage rule in the identified multiple duplication destination storage media (111 to 113) in stages.

The storage system according to the present invention is provided with an access frequency detection section (142). This access frequency detection section (142) counts the number of accesses to each of the blocks stored in the multiple storage media to detect the access frequency. In this case, the duplication source area determination processing section (144) determines the duplication source areas (100 to 108), with information about such a block that the access frequency exceeds a predetermined access frequency, the information being received from the access frequency detection section (142), or duplication source area specification information from the outside as the duplication start signal. The duplication destination determination processing section (143) may determine the duplication destination storage media (111 to 113) in ascending order of the access frequency. The duplication processing section (144) may generate duplicates of 50% or more of the multiple blocks included in the duplication source areas (100 to 108), and distribute and store the duplicates in the duplication destination storage media (111 to 113).

In the case of generating duplicates of a part of the multiple blocks included in the duplication source areas (100 to 108), the duplication processing section (144) may always generate a duplicate of a top part block (top block (100)) and store the duplicate of the top block in a duplication destination storage medium.

The storage system is further provided with an access allocation processing section (145). When a request to access a block is a read request and there is a duplicate of the access target block, the access allocation processing section (145) allocates the read request to the duplicated block. When the access request is a request to read data which is dividedly stored in multiple blocks and there are already multiple duplicates of a block to be the access destination, the access allocation processing section (145) changes the access destination block to a duplicated block on a storage medium having the least number of duplicated blocks related to the data. Alternatively, when there are already multiple duplicated blocks of a block to be the access destination, the access allocation processing section (145) changes the access destination block to a duplicated block on a storage medium with the lowest access frequency.

In the storage system, each of the multiple storage media (110 to 113) may be virtualized. Here, the multiple storage media have pool areas (410 to 413) in which original blocks are stored and common areas (420 to 423) in which duplicated blocks are stored, respectively. In this case, the duplication processing section (144) stores the duplicates of the multiple blocks in the common areas (420 to 423) of the duplication destination storage media (111 to 113).

The storage system may be further provided with a block state changing processing section (130). In this case, the block state changing processing section (130) performs processing for changing the area state of the pool areas (410 to 413) and the common areas (420 to 423) in the duplication source storage medium (110) and the duplication destination storage media (111 to 113) to exchange the duplicated blocks and the original blocks.

Further characteristics of the present invention will be apparent from Best Modes for Carrying Out the Invention below and accompanying drawings.

### Advantageous Effects of Invention

According to the present invention, it is possible to drastically improve the distribution performance with a small amount of data duplication, and it is possible to solve sudden concentration of accesses to a particular storage medium even in distribution of contents with a large capacity.

### BRIEF DESCRIPTION OF DRAWINGS

FIG. 1 is a diagram showing the schematic configuration of a contents distribution system (storage system) according to a mode for the present invention 1.

FIG. 2 is a diagram showing the RAID structure.

FIG. 3 is a diagram showing the configuration of programs on a memory.

FIG. 4 is a diagram for illustrating the result of duplication by a conventional technique.

FIG. 5 is a diagram showing the result of duplication according to the present invention in the case of using four storage media.

FIG. 6 is a diagram showing the advantageous effects of the present invention in the case of using four storage media.

FIG. 7 is a diagram showing the result of the duplication according to the present invention in the case of using five storage media.

FIG. 8 is a diagram showing the advantageous effects the present invention in the case of using five storage media.

FIG. 9 is a flowchart for illustrating the operation of an access traffic management program.

FIG. 10 is a flowchart for illustrating the operation of a duplication destination storage medium determination program.

FIG. 11 is a flowchart for illustrating the operation of a duplication processing program.

FIG. 12 is a flowchart for illustrating the operation of an access destination allocation program.

FIG. 13 is a flowchart for illustrating the operation of a duplication start program.

FIG. 14 is a diagram showing the concept of the operation between a host and a contents storage apparatus.

FIG. 15 is a diagram showing the schematic configuration of a contents distribution system (using virtualized storage media) according to a mode for the present invention 2.

FIG. 16 is a diagram showing the details (example) of a virtualization table.

FIG. 17 is a diagram showing the result of the duplication according to the present invention in the virtualized storage media.

### REFERENCE SIGNS LIST

10: contents storage apparatus (storage apparatus)
100: block area on storage medium
110: storage medium
120: interface
130: control device
140: memory
141: initial setting program
142: access traffic management program
143: duplication destination storage medium determination program
144: duplication processing program
145: access destination allocation program
146: duplication start program
150: host
151: file system and file system control program
152: setting program
160: terminal
170: drive
180: logical drive
200: performance of conventional method
201: performance of method of the present invention
300: virtualization section
301: virtualization table

### BEST MODES FOR CARRYING OUT THE INVENTION

The present invention relates to a contents distribution system (storage system) which, while maintaining information of contents stored in a duplication source storage medium (for example, information in blocks) as it is, distributes and stores duplicates of the information in multiple distribution destination storage media uniformly (for example, in stripes).

Modes for the present invention will be described below with reference to accompanying drawings. However, it should be understood that the modes are only examples for realizing the present invention and do not limit the technical scope of the present invention. Components common to the drawings are given the same reference numerals.

### (1) First Embodiment

### Configuration of Contents Distribution System

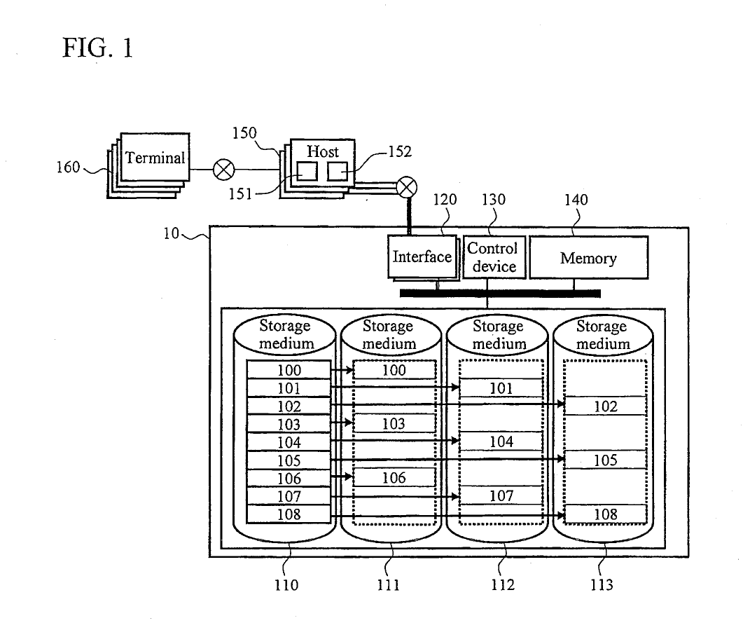

FIG. 1 is a diagram showing the schematic configuration of a contents distribution system according to a mode for the present invention 1. The contents distribution system shown in FIG. 1 is provided with a contents storage apparatus 10 and a host (computer) 150, and it is an apparatus which distributes contents to a terminal 160 connected via a network such as the Internet, by cooperated operations by the contents storage apparatus 10 and the host 150 for distributing contents. The contents storage apparatus 10 and the host 150 are connected by a network such as a fiber channel and Ethernet (registered trademark) via an interface 120.

The contents storage apparatus 10 operates by an internal control device 130 executing a program mounted on a memory 140. The host 150 and the terminal 160 are similarly provided with a control device and a memory, and operate by the control device executing a program on the memory. The memory of the host 150 holds a file system and a file system control program 151 for performing writing and reading of contents, and a setting program 152 for performing initial settings and the like for the contents storage apparatus 10 and realizes processing on the host 150 side among cooperated operations by the contents storage apparatus 10 and the host 150. It is also possible that the programs mounted on the memory 140 of the contents storage apparatus 10 are mounted on the memory 140 of the host 150 or the memory of a different or a different apparatus (not shown), and the operation of the contents storage apparatus 10 is controlled from the host 150 or the different apparatus (not shown).

The contents storage apparatus 10 is provided with multiple storage media 110 to 113 which are physically different from one another, and information on each of the storage media is managed in blocks, the size of the block being determined in advance. Contents are dividedly stored in the storage medium in blocks. For example, contents can be dividedly stored in blocks 100 to 108 of the storage medium 110.

The contents are basically stored in consecutive blocks in order of block number. However, it does not matter if there is an inconsecutive part.

In the present invention, when duplicates of contents are created, the duplicates are created in the different storage media in blocks and in stripes (uniformly). To make duplicates in stripes means to perform duplication in such an arrangement of duplicates that, when contents data are sequentially read, accesses are made to the different storage media 110 to 113 sequentially and circulatingly. For example, in the case of duplicating contents stored in the consecutive blocks 100 to 108 of the storage medium 110 in order of block number, on the storage media 111 to 113, the blocks 100, 103 and 106 are stored in the storage medium 111, the blocks 101, 104 and 107 are stored in the storage medium 112, and the blocks 102, 105 and 108 are stored in the storage medium 113. By uniformly creating the duplicates in the duplication destination storage devices, the reading performance can be improved. The present invention is characterized in that: contents are not stored in stripes when they are stored in a storage medium first, but they are stored in one storage medium (duplication source), and after that, duplicates are stored in the other storage media (duplication destinations) in stripe on the basis of an instruction from the host or in the case where the access frequency is higher than a predetermined threshold.

<Structure of RAID>

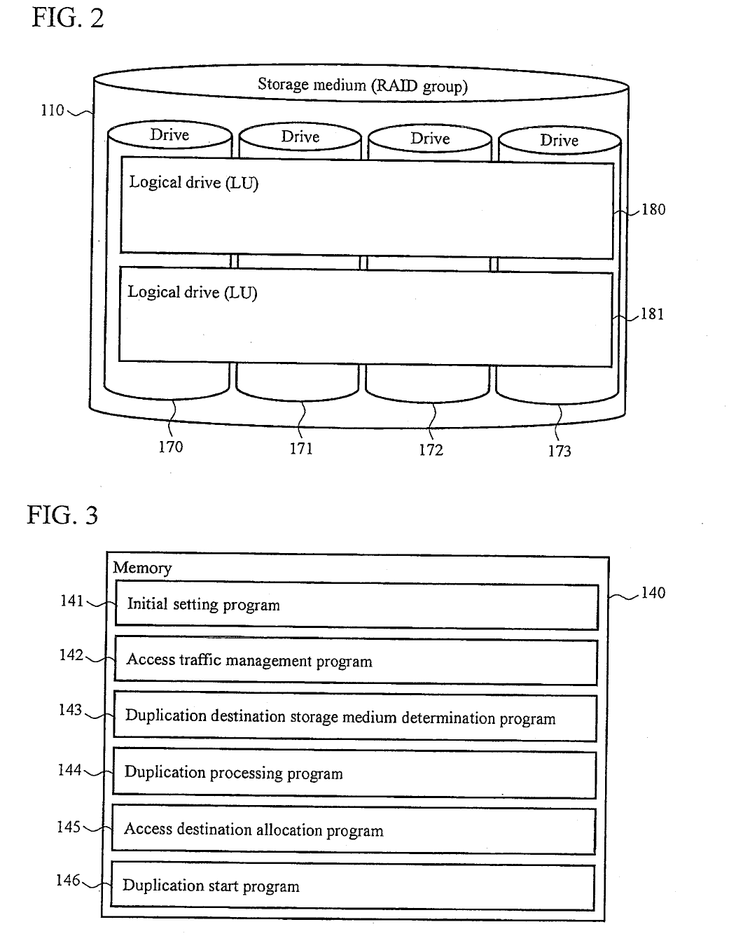

FIG. 2 shows a RAID (Redundant Arrays of Inexpensive) structure in one storage medium (one of 110 to 113). The RAID couples physically different storage media (sub storage areas) 170 to 173 to realize one huge storage medium (a RAID group). Multiple logical storage media LU's (Logical Units) 180 and 181 can be created on the RAID group. Each of the storage media mounted on the contents storage apparatus 10 may be of the RAID structure. However, in the case where multiple LU's exist in one RAID group, the LU's cannot be used as different storage areas because they physically exist on the same storage area. That is, it is meaningless to duplicate data existing on the LU 180, on the LU 181, and the reading performance is not improved thereby. It is because the LU's 180 and 181 exist on the same storage medium.

<Configuration of Programs>

FIG. 3 shows the programs on the memory 140 of the contents storage apparatus 10. On the memory 140, there are stored an initial setting program 141, an access traffic management program 142, a duplication destination storage medium determination program 143, a duplication processing program 144, an access destination allocation program 145 and a duplication start program 146.

The details of each program will be described later. Briefly explaining each of them, the initial setting program 141 has a function for receiving a setting instruction from the host 150 and making various settings (parameters, target performance and the like). The access traffic management program 142 has a function for managing how much access is made to which storage medium (contents). The duplication destination storage medium determination program 143 has a function for selecting copy destination storage media (including the number thereof) on the basis of target performance. The duplication processing program 144 has a function for performing duplication in consideration of the order of copying. Furthermore, the access destination allocation program 145 has a function for allocating a read access to a copy destination. The duplication start program 146 has a function for giving a trigger for starting duplication (a duplication start signal).

Each program functions as a processing section in cooperation with the control device 130. That is, for example, the access traffic management program 142 operates as an access traffic management processing section in cooperation with the control device 130.

<Result and Advantageous Effects of Duplication: Comparison Between Conventional Technique and the Present Invention>

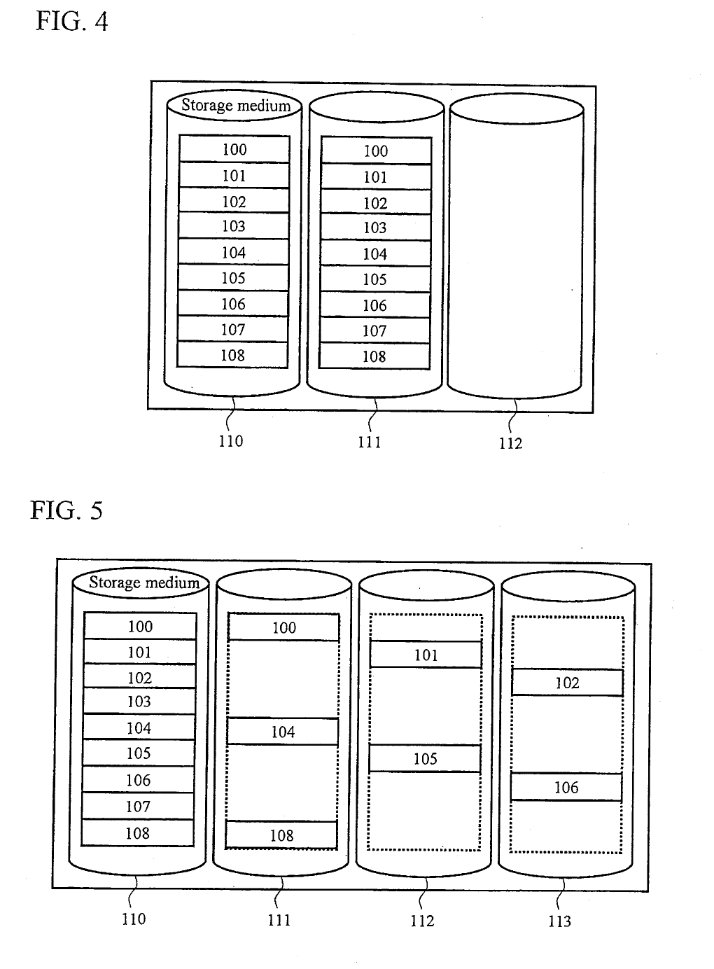

FIG. 4 shows the result of duplication of contents according to a conventional technique. When contents are duplicated from the storage medium 110 onto the storage medium 111 and, for example, the contents are stored in the blocks 100 to 108 on the storage medium 110, blocks having the same contents of the blocks 100 to 108 are also created on the storage medium 111. By allocating accesses to the storage media 110 and 111, it becomes possible to read the contents with twice the reading performance specific to the storage media. In the case of requiring further improvement of performance, reading of the contents can be performed with almost three times the performance by similarly creating a duplicate in the different storage medium 112. That is, it is necessary to perform duplication of the amount of data corresponding to n-times the data size of the contents in order to realize n-times improvement of performance. However, the duplication as shown in FIG. 4 is intended mainly for backup, and it is a wasteful (inefficient) duplication method when only the purpose of improving reading performance is considered.

Now, duplication according to the present invention will be considered. FIG. 5 shows the result of the duplication according to the present invention in the case of using four storage media (including a duplication source). For example, when contents are stored in the blocks 100 to 108 on the storage medium 110, duplicates are made in the multiple different storage media in stripes (uniformly), for example, in such a manner that the blocks 100, 104 and 108 are stored in the storage medium 111, the blocks 101 and 105 are stored in the storage medium 112, and the blocks 102 and 106 are stored in the storage medium 113. Thereby, it is possible to realize higher reading performance than the conventional method, with the same amount of duplicated data as that in the conventional method. In the example of FIG. 5, it becomes possible to read contents with almost four times the reading performance (reading band) specific to the storage media.

In this duplication processing, duplication can be performed in such an order that the number of storage media for storing duplicated data increases in stages according to increase in access from the host 150. For example, the block 100, the block 104 and the block 108 are duplicated in the storage medium 111 at the first stage, the block 101 and the block 105 are duplicated in the storage medium 112 at the second stage, and the block 102 and the block 106 are duplicated in the storage medium 113 at the third stage. For example, by terminating duplication at the first stage or the second stage described above in the case where the number of accesses does not increase as expected at the time of starting the duplication, it is possible not only to spare unnecessary duplication of data but also to obtain the merit of easily using an unused storage medium for other purposes.

Reversely, in the case of performing duplication in order of reading the data, such as in the order of the block 100, the block 101, the block 102, . . . , it is possible to improve performance locally up to the maximum performance in the order of the positions where duplication is performed, and therefore, it is advantageous when it is desirable to early speed up a position to which accesses are especially easily concentrated such as the top part of contents. Such a duplication policy can be freely set and changed for each duplication of contents.

It is because actual duplication processing is performed after duplication destination storage media (including the number thereof) are determined on the basis of target performance, and which block duplicates are to be stored in the storage media in stripes (uniformly) is determined as described later, that such duplication processing in stages is possible.

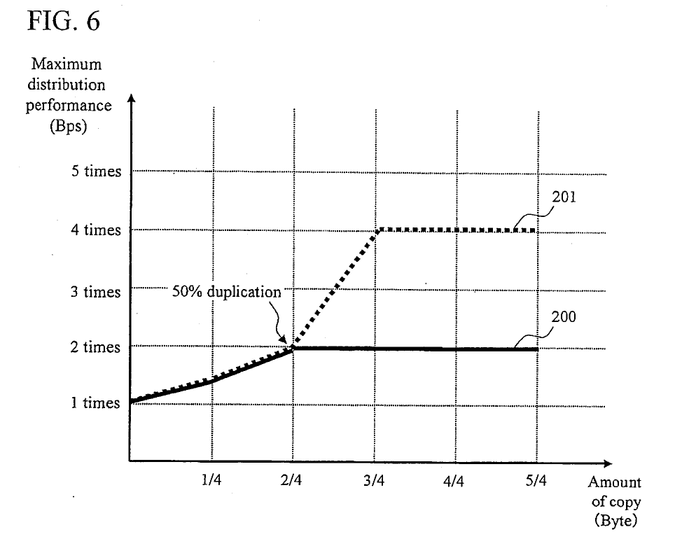

FIG. 6 is a diagram for illustrating the advantageous technical effects of the present invention in the case of using four storage media (including a duplication source). In FIG. 6, the vertical axis of the graph indicates the maximum contents distribution performance and the horizontal axis indicates the amount of duplicated data of contents. A solid line 200 indicates a performance curve of the conventional method, and a broken line 201 indicates a performance curve of the method of the present invention.

As shown in the graph of FIG. 6, there is not difference in the effect of improvement of the maximum performance in comparison with the conventional method immediately after start of duplication, the maximum performance of the method of the present invention can be improved to be almost fourfold, unlike the conventional method, when the amount of duplicated data exceeds 50% of the total amount of contents (in this example, 4.5 blocks because there are 9 blocks). That is, it is known that 1.5 times the usual storage capacity is required in the case of desiring to obtain a characteristic capable of immediately and drastically improving the reading performance, but quick improvement of the reading performance can be realized if 50% of duplication is performed in advance.

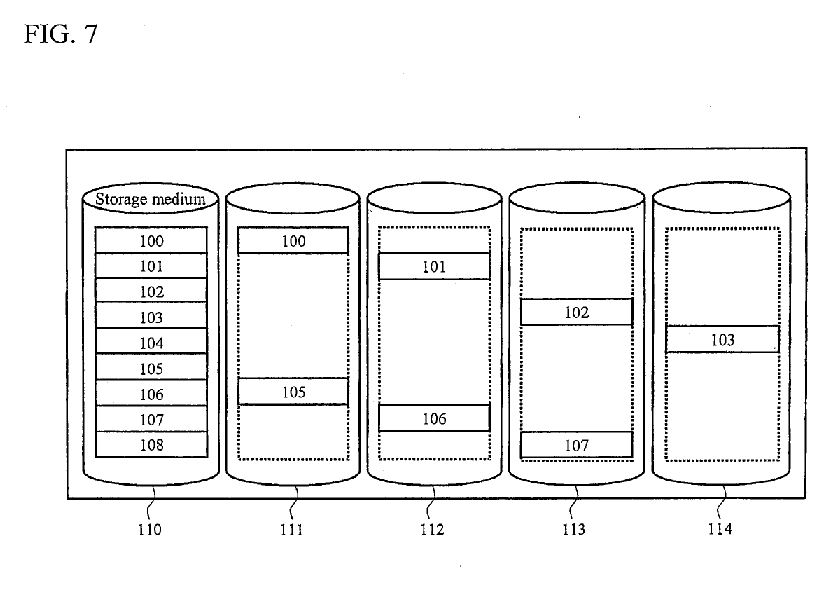

FIG. 7 shows the result of the duplication according to the present invention in the case of using five storage media (including a duplication source). When the number of storage media to be duplication destinations changes, the optimum block duplication pattern changes. If contents are stored in the blocks 100 to 108 on the storage medium 110 similarly to the case of using four storage media, the duplication destinations are different from the case of using four storage media, and duplicates are made in the multiple different storage media in stripes (uniformly), for example, in such a manner that the blocks 100 and 105 are stored in the storage medium 111, the blocks 101 and 106 are stored in the storage medium 112, the blocks 102 and 108 are stored in the storage medium 113, and the blocks 103 is stored in the storage medium 114. According to the example of using five storage media as in FIG. 7, it is possible to realize further higher performance with the amount of duplicated data similar to that in the case of using four storage media (FIG. 5). In the example of FIG. 7, it becomes possible to read contents with almost the five times the reading performance specific to the storage media.

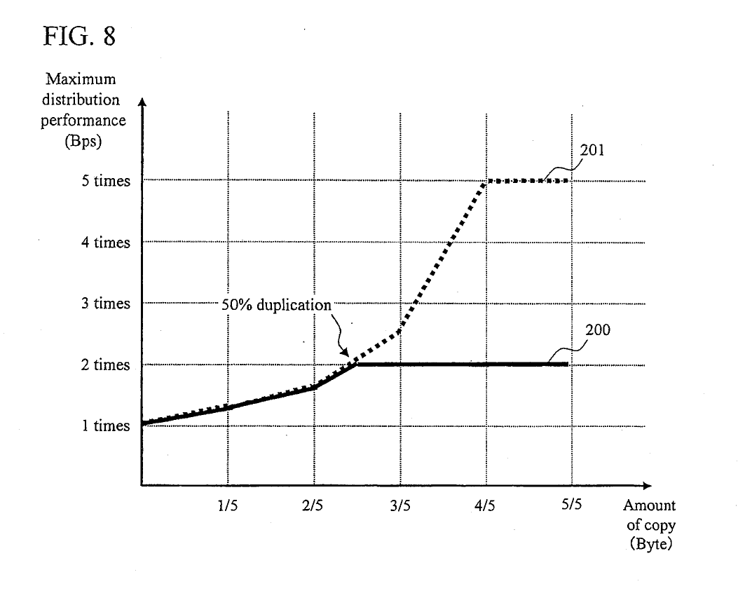

FIG. 8 is a diagram for illustrating the advantageous technical effects of the present invention in the case of using five storage media. As shown in FIG. 8, the vertical axis of the graph indicates the maximum contents distribution performance and the horizontal axis indicates the amount of duplicated data of contents, similarly to the case of using four storage media (FIG. 6). A solid line 200 indicates a performance curve of the conventional method, and a broken line 201 indicates a performance curve of the method of the present invention.

As shown by the graph in FIG. 8, there is not difference in the effect of improvement of the maximum performance in comparison with the conventional method immediately after start of duplication, the maximum performance of the method of the present invention can be improved to be almost fivefold, unlike the conventional method, when the amount of duplicated data exceeds 50% of the total amount of contents. That is, in the present invention, it is possible to obtain a higher effect of improvement of performance in comparison with the conventional method when duplication of 50% or more of the total amount of contents is performed. However, since the block duplication pattern differs according to the number of storage media to be duplication destinations, it is necessary to determine the number of storage media and the duplication pattern suitable for target performance in advance.

<Contents of Operation of Each Program>

The contents of the operation of each program on the memory 140 will be described below. As described above, each of the programs 141 to 146 operates as each processing section (for example, the initial setting processing section and the access traffic management processing section) in cooperation with the control device 130.

i) Initial Setting Program (Initial Setting Processing Section)

The initial setting program (initial setting processing section) 141 executes initialization processing of various parameters used by the other programs. Specifically, it performs setting (recognition) of constants, such as the size of the blocks described above, setting about whether duplication is performed in such an order that the number of storage media which use duplicates increases in stages as specified in the duplication policy described above or in the order of data arrangement for the purpose of early speeding up the top position, and the like.

Processing for changing the settings is realized by the input data being sent to the initial setting program 141 on the contents storage apparatus 10 from the host 150 by an administrator inputting a set value using the setting program 152 on the host 150, and the initial setting program 141 performing rewriting with the specified set value. The settings can be changed not only when the contents storage apparatus 10 is activated but also any time after the activation and any number of times.

The initial setting program 141 also holds basic hardware configuration data such as the number and performance of the storage media connected to the contents storage apparatus 10.

ii) Access Traffic Management Program (Access Traffic Management Processing Section)

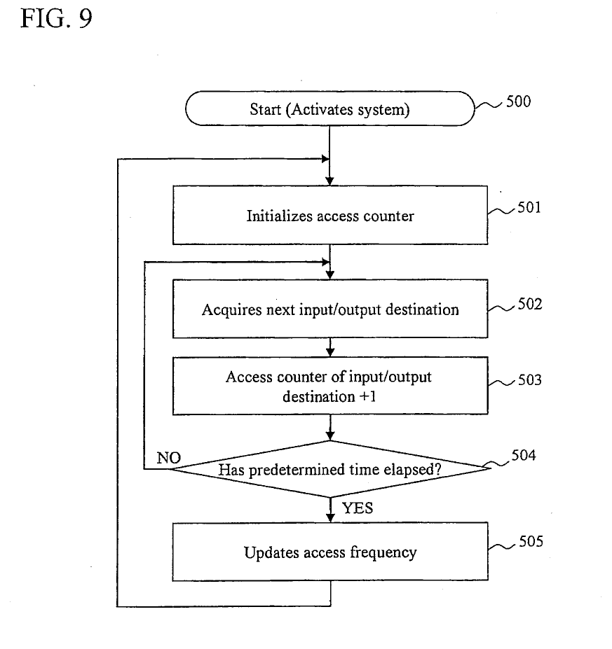

FIG. 9 is a flowchart for illustrating the operation of the access traffic management program (access traffic management processing section) 142. The access traffic management program 142 is a program for managing how much access is made to which storage medium. This program is required for selecting storage media with a low access load which are to be data duplication destinations or in the case of desiring to automatically determining storage media or blocks in which data to be duplicated is stored without notification from the host 150.

First, execution of the program is started, being triggered by activation of the system (step 500). Next, the access traffic management processing section 142 initializes access counters for counting the number of accesses to set all counter values to 0 (step 501). A counter is prepared for each block, each set of a predetermined number of blocks or each storage medium. Each time the contents storage apparatus 10 receives an input/output request from the host 150 (step 502), the access traffic management processing section 142 counts up a counter corresponding to the access destination (step 503).

Then, the access traffic management processing section 142 repeats the procedures of step 502 to step 503 until a predetermined time elapses (step 504). When the predetermined time has elapsed, the access traffic management processing section 142 acquires the counter value at that time as the latest access frequency data.

The processing returns to step 501, and the access traffic management processing section 142 repeats the procedures of step 501 to step 505. Thereby, it is possible to keep the access frequency data in the latest state for the predetermined time.

iii) Duplication Destination Determination Program (Duplication Destination Determination Processing Section)

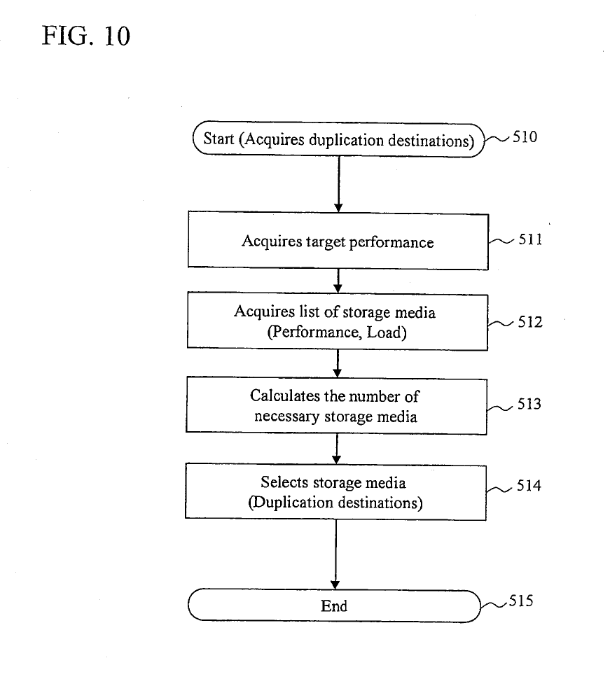

FIG. 10 is a flowchart for illustrating the operation of the duplication destination storage medium determination program (duplication destination determination processing section) 143. The duplication destination storage medium determination program 143 executes processing for selecting the number of storage media required for achieving target performance and storage media to be duplication destinations from among the multiple storage media connected to the contents storage apparatus 10.

This program is called when the duplication processing program 144 or the like needs to acquire duplication destination storage media (step 510).

First, the duplication destination determination processing section 143 acquires information about target performance (step 511). As the target performance, a value set by the initial setting program 141 is used. For example, by the administrator changing the set value from the host 150, it is possible to set different target performance for each duplicated data.

Next, the duplication destination determination processing section 143 acquires information about a list of the storage media (step 512). The list of storage media is a list of data such as the free space, performance, access frequency and the like of the storage media, and it can be created by acquiring the hardware configuration data held by the initial setting program 141 and the access frequency data held by the access traffic management program 142.

Next, the duplication destination determination processing section 143 determines the number of necessary storage media (step 513) and selects storage media (step 514). When there is no access to the storage medium, the number of storage media can be easily determined by dividing target performance (bytes/sec) by the performance of the storage media (bytes/sec). When the performance is not the same among all the storage media, an average value of the performance values of all the storage media can be used. When there is access to the storage medium, it is necessary to subtract performance corresponding to an access load calculated by the number of accesses×the block size/the-number-of-accesses measurement time from the performance of the storage medium and sequentially select storage media in descending order of surplus capacity until the target performance is satisfied. The duplication destination storage media can be determined by the above procedures (step 515). When the number of storage media configured in the contents storage apparatus 10 is larger than the number of storage media to be selected, selection may be performed in descending order of capacity.

iv) Duplication Processing Program (Duplication Processing Section)

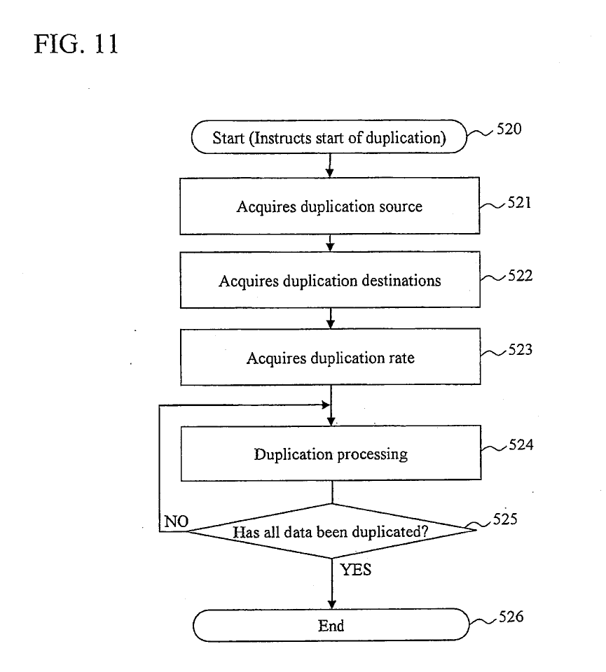

FIG. 11 is a flowchart for illustrating the operation of the duplication processing program (duplication processing section) 144. The duplication processing program 144 starts, being triggered by a duplication instruction from the host 150 or the duplication start program 146 to be described later (step 520).

First, the duplication processing section 144 acquires information about a block to be a duplication source, which has been determined by the host 150 or the duplication start program 146 (step 521). That is, the information about the destination source block is specified by the administrator from the host 150 or specified by the duplication start program 146 when the frequency of access to a particular storage medium (contents) becomes higher than a predetermined value.

Next, the duplication processing section 144 acquires information about blocks to be duplication destinations by executing the duplication destination storage medium determination program 143 (step 522).

Then, the duplication processing section 144 acquires a duplication rate or a duplication policy managed by the initial setting program 141. Here, the duplication rate is a parameter specifying the speed (bytes/sec) of duplication. The duplication policy is a parameter specifying the order of duplication, for example, a parameter specifying whether duplication should be performed in such an order that the number of storage media to be used increase in stages.

Next, the duplication processing section 144 executes duplication processing in accordance with the acquired duplication rate and duplication policy (step 524). In this case, the duplication processing program 144 records and manages which block has been duplicated in which place.

When the duplication processing section 144 executes the duplication processing until duplication of all the data, which is the duplication source, is completed (step 525), the duplication processing program 144 ends the operation (step 526).

v) Access Destination Allocation Program (Access Destination Allocation Processing Section)

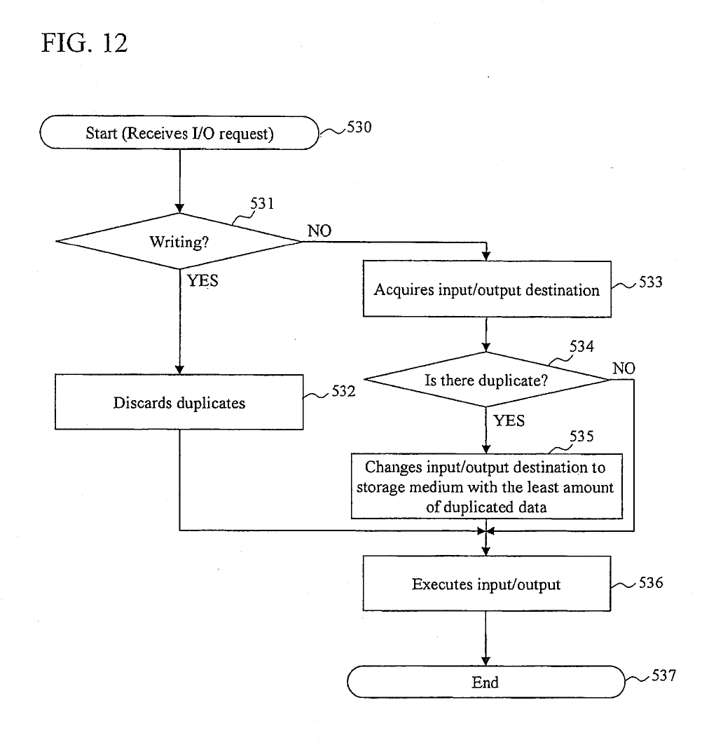

FIG. 12 is a flowchart for illustrating the operation of the access destination allocation program (access destination allocation processing section) 145. The access destination allocation program 145 is a function of, when data on a storage medium is accessed from the host 150 and there is a duplicate of the data, allocating the access to the duplicated data as the destination. When the duplication start program 146 to be described later is invalid, this program is also invalidated. The operation will be described below.

First, when receiving an input/output request from the host 150 (step 530), the access destination allocation processing section 145 judges whether the input/output is writing or reading (step 531).

If the request is writing processing, the access destination allocation processing section 145 discards duplicates (step 532) and executes writing processing (step 536). In this case, it is notified to the duplication processing program 144 that the duplicates have been discarded, and the duplication processing program 144 updates a duplication state record which it internally manages. In the case of new writing, the access destination allocation processing section 145 notifies the duplication processing program 144 of addition of original data and writes the data to a block to be the access destination (step 536). For example, when contents data is updated by editing, only the original data in the duplication source storage medium 110 is updated, and duplicated data is discarded. When duplication is necessary, the series of processings are executed again in accordance with FIGS. 9 to 11 and FIG. 13.

On the other hand, if the request from the host 150 is reading processing, the access destination allocation processing section 145 refers to the duplication record managed by the duplication processing program 144 to check which block on which storage medium the access destination of the input/output request is (step 533). If there is a duplicate of the access destination block, the access destination allocation processing section 145 changes the access destination to the duplicated data. When duplication is performed for the first time, only one duplicate exists. However, a situation is also conceivable in which duplicates exist in multiple places, for example, in the case where duplication is performed again because the target performance is changed or in the case where the access frequency is very high and only one duplicate is not enough to distribute concentration of accesses (it is required that there are a sufficient number of storage media). If there are multiple duplicates of the same block, it is also possible to select a storage medium holding less duplicated data or a storage medium with a lower access frequency (step 535) and execute reading processing (step 536). As for such a situation in which multiple duplicates exist, it is possible to grasp the places of the duplicates once made by a virtualization table. Therefore, it is especially necessary to consider the situation on the assumption of virtualized storage media to be described in a mode for the invention 2.

If duplicated data does not exist, the access destination allocation processing section 145 skips step 535 and executes reading processing (step 536). Now, the access destination allocation program 145 ends (step 537). As described above, it is when an I/O request is a read request that the allocation processing is executed.

vi) Duplication Start Program (Duplication Start Processing Section)

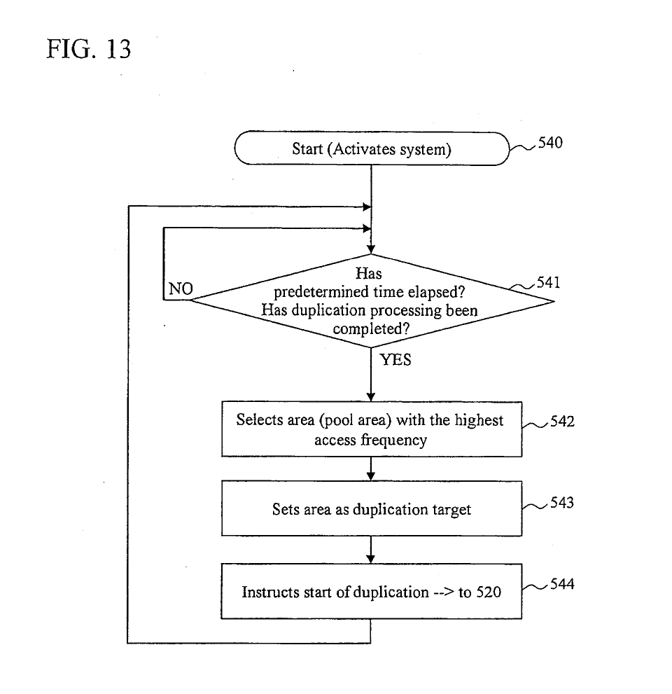

FIG. 13 is a flowchart for illustrating the operation of the duplication start program (duplication start processing section) 146. For the duplication start program 146, the administrator can select “valid/invalid” (whether or not to execute the duplication start program) at the initial setting using the initial setting program 141. When “invalid” is selected, the administrator specifies contents (blocks) to be duplicated, from the host 150, irrespective of the access traffic.

When “valid” is selected, the duplication start program 146 starts processing (step 540) at the time of activation of the system so that the duplication processing is automatically started in the contents storage apparatus 10 without an instruction from the host 150.

First, the duplication start processing section 146 waits until the number of duplication processings being executed is less than the maximum number of simultaneous processings and a predetermined time managed by the initial setting program 141 elapses (step 541). However, if the predetermined time is shorter than the measurement time of the access traffic management program 142, the duplication start processing section 146 waits until the measurement time of the access traffic management program elapses after activation of the system. If the above condition is satisfied, the duplication start processing section 146 refers to the access frequency data managed by the access traffic management program 142 to select an area with the highest access frequency (step 542).

Then, the duplication start processing section 146 sets the selected area as the duplication source (step 543) and instructs the duplication processing program 144 to start duplication processing (step 544). That is, the processing in this case corresponds to step 544-->step 520.

<Communication Operation Between Host and Contents Storage Apparatus (Example)>

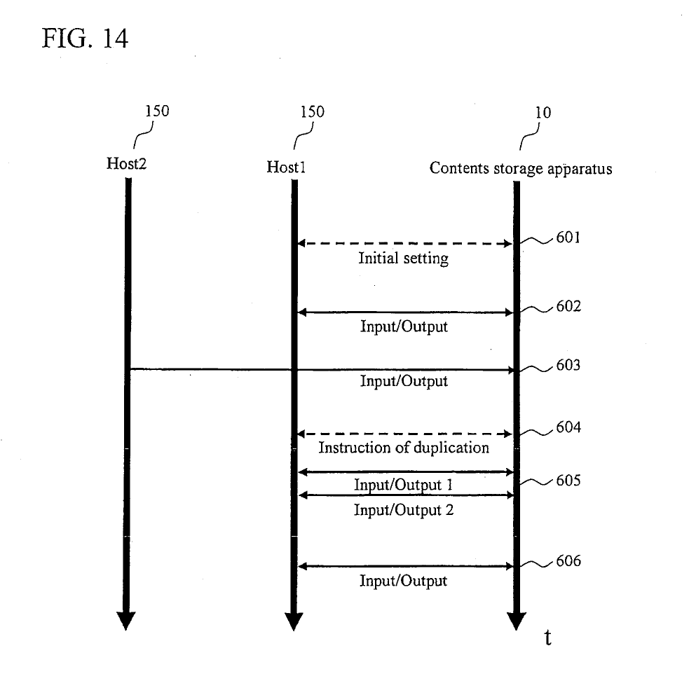

FIG. 14 is a sequence diagram for illustrating the operation between the host 150 and the contents storage apparatus 10 (example).

First, the administrator performs initial setting for the contents storage apparatus 10 using the setting program 152 on the host 150 (step 601). After that, the initial setting procedure can be executed any number of times, and the setting contents can be dynamically set and changed.

Then, the host 150 transmits an input/output request to the contents storage apparatus 10 and performs input/output of data (step 602). The input/output may be performed from a different host 150 at the same time (step 603).

When the duplication start program 146 is set to “invalid” by the initial setting, a duplication source and duplication destinations are specified from the host 150 to give a duplication start instruction (step 604). When the host 150 omits the duplication destinations, the duplication destination storage medium determination program 143 of the contents storage apparatus 10 determines duplication destinations and notifies them to the host 150. Thereby, the file system 151 of the host 150 can distribute and issue the input/output requests to the duplication destinations notified at step 604 and the duplication source which is original data (step 605).

When the duplication start program 146 is valid, it is not necessary to give a special instruction from the host 150 because duplication is automatically executed, and allocation to the duplicated data is automatically executed only by performing input to or output from the duplication source (step 606).

### (2) Mode for the invention 2

A mode for the invention 2 relates to duplication in virtualized storage media. The virtualized storage medium is a technique for showing a capacity larger than the actual capacity of a storage medium to a host, which is called thin provisioning or the like, and it is a method in which reduction in equipment cost and power consumption can be expected in an environment where there is a difference between the maximum storage capacity desired to be prepared in advance and the capacity actually used. Specifically, at the time when a storage medium is virtually created, a physical storage medium area is not assigned, and the storage medium is presented as an unsubstantial but available storage area to the host. When there is a request for writing in the storage area from the host, an actual area is assigned on demand. Therefore, the host cannot recognize the difference between a normal storage medium and the virtual storage medium.

<Configuration of Contents Distribution System>

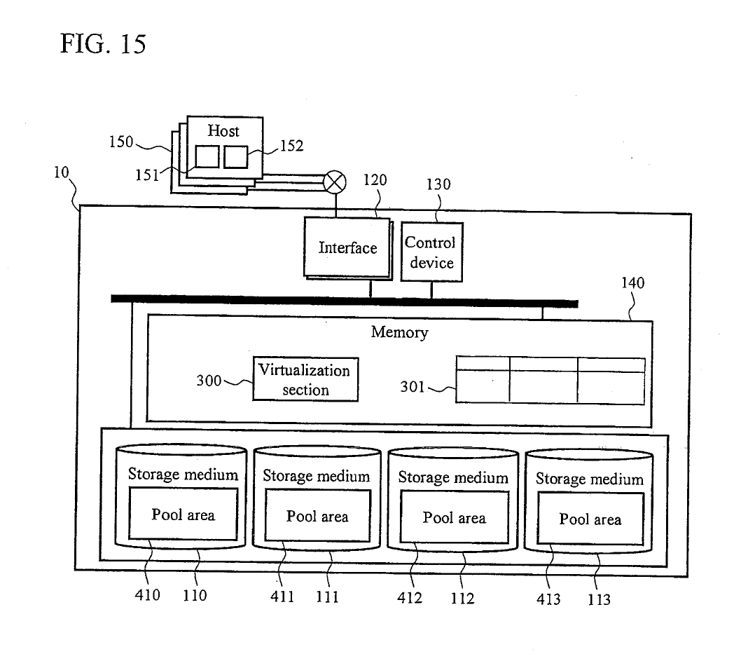

FIG. 15 is a diagram showing the schematic configuration of a contents distribution system (storage system) having virtualized storage media, according to the mode for the present invention 2. On the memory 140, there are a virtualization program 300 for performing virtualization processing and a virtualization table 301 for recording correspondence relationships between virtual storage areas and actual storage areas.

The storage media 110 to 113 are provided with pool areas (410 to 413) for pooling empty blocks to be assigned to virtual areas on demand and common areas 420 to 423 (see FIG. 17) which are provided for storing duplicated blocks. The other parts of the configuration are similar to those of the mode for the invention 1, description thereof will be omitted.

<Virtualization Table>

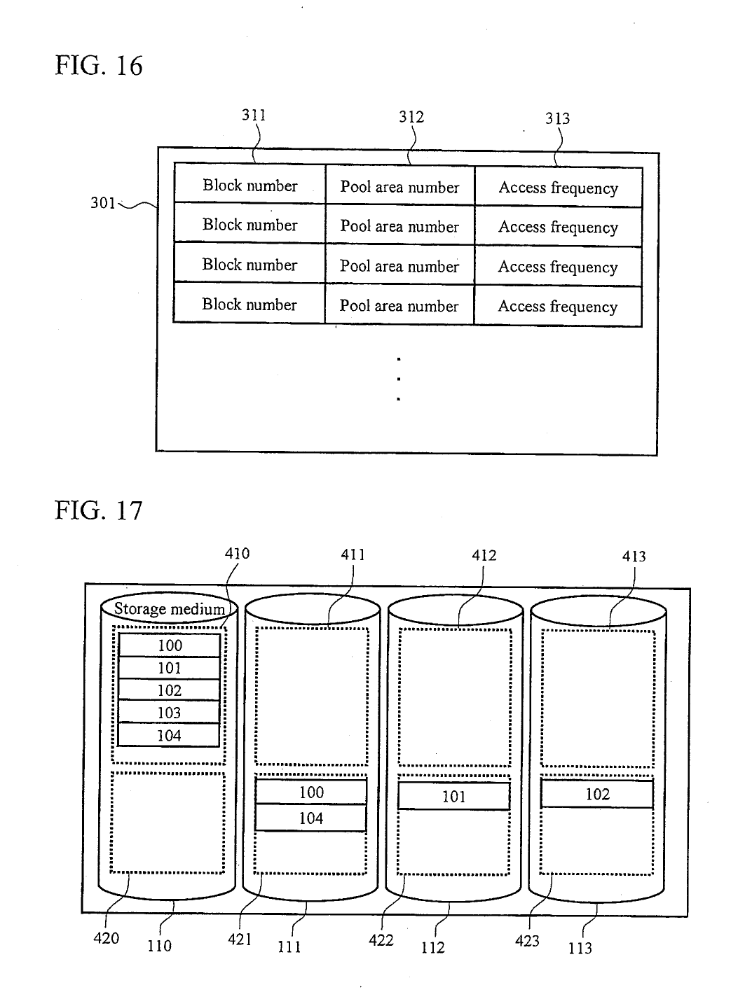

FIG. 16 is a diagram showing the detailed configuration of the virtualization table 301. The virtualization table 301 is configured by pairs of a pool area number 312 corresponding to a virtual block number 311 of a virtual storage medium and the access frequency 313 of the area.

When a write access is made from the host 150, the control device 130 checks all the block numbers 311 in the virtualization table 301. If there is a corresponding line, the control device 130 performs control so that writing into the area of the storage medium specified by the pool area number on the line is performed. If there is not a corresponding block number 311 in the virtualization table 301, the control device 130 assigns one empty block from among the pool areas 410 to 413, performs writing of data, and adds a line showing the correspondence relationship between the block number 311 and the pool area number 312 to the virtualization table 301.

In the case of performing reading from the host 150 also, if there is similarly a block number 311 in the virtualization table 301, the control device 130 performs control so that the contents of a corresponding pool area number 312 is read. If there is not a corresponding block number 311, the control device 130 notifies that appropriate data does not exist in the storage media by returning predetermined undefined data (such as all-zero data) to the host 150.

<Duplication Result>

FIG. 17 is a diagram showing the result of duplication in virtualized storage media. When blocks 100 to 104 exist in the pool area 410 on the storage medium 110, the blocks are duplicated in the common areas 420 to 423 prepared in the storage media, respectively. Specifically, the block 100 is duplicated in any of the common areas 412 to 423 on the physically different storage media. Similarly, the blocks 101 to 104 are duplicated in the common areas 412 to 423 of the physically different storage media. Here, the common areas are areas secured for duplication separately from the pool areas, and, for example, the area size of the common areas is determined in advance. By separating the pool areas and the common areas like this, it is possible to secure areas for storing source data and duplicated data. That is, if the areas for both data are not secured in advance, there is a possibility, in the case of virtualization, that any one of the data is stored, so that both data cannot be stored in each storage medium.

When there is no empty block in the common areas 420 to 423, processing for rewriting onto old data on the common areas 420 to 423 selected by an algorithm, such as LRU (Least Recently Used), can be performed. Thus, the present invention can be applied even to virtualized storage media.

In the virtualized storage media, by moving the data of a duplicated block from the common area 421 to a pool area of the physically same storage medium and deleting the original block, it is possible to change the contents arrangement to be contents arrangement with permanently high reading performance. In the case of performing such permanent optimization of contents arrangement, there is a method in which a duplicate is created not in a common area but in a pool area at the time of duplication, and a method in which whether the block is in a common area or a pool area is managed by a flag, and blocks in a common area and in a pool area are exchanged by changing the flag (a duplicated is caused to be an original), in order to avoid occurrence of copying from a common area to a pool area. In this case, as the empty block in the pool area to be the exchange destination, an unused block in the pool area can be simply selected. However, it is desirable to notify an area which becomes unused from the file system and the file system control program 151 in advance to release the unnecessary block to prevent the unused block from being depleted.

The idea of separating an area for storing original data and an area for storing duplicated data as described above can be also applied to the system of the mode for the invention 1.

### (3) Summary

A storage medium has the maximum data input/output performance specific to the medium. Therefore, in the case where input/output performance exceeding this maximum performance is required, it is essential to distribute and store data in multiple storage media. Thus, the present invention is applicable to all fields requiring a storage device.

In the present invention, in a storage system having multiple storage media which are physically separated, duplicates of multiple blocks forming particular contents are generated, and the duplicated blocks are uniformly stored in storage media other than the storage medium which stores the particular contents. Thereby, it is possible to uniform the reading performances of the storage media and reduce concentration of accesses to a particular storage medium.

That is, more specifically, the multiple storage media are multiple storage media which are physically different from one another and each of which is configured by multiple blocks. Then, in response to a duplication start signal (in the case where an instruction is given from a host or in the case where the access frequency of a particular storage medium increases to a predetermined value or above), duplication source areas configured by multiple blocks, which are to be a duplication source are determined among the multiple storage media. Then, duplicates of the multiple blocks included in the duplication source areas are generated, and the duplicates of the multiple blocks are distributed and stored in multiple storage media (duplication destination storage media) other than the storage medium which includes the duplication source areas. Since duplicates of block data of a duplication source are distributed and stored in duplication destination storage media as described above, it is possible to distribute concentration of accesses to each storage medium without giving bad influence of consuming the storage capacity of each storage medium due to duplication. This is an excellent advantageous technical effect in comparison with the duplication for backup in FIG. 4.

On the basis of target performance (reading performance) specified by a host and the performance of multiple storage media (for example, an average value of the reading performances of the storage media), multiple duplication destination storage media which are to be storage destinations of duplicates of blocks and are required for satisfying the target performance are identified (identification of the number of storage media and duplication destinations). Furthermore, a storage rule for causing the duplicates of the multiple blocks to be distributed and stored in the identified duplication destination storage media in stripes is determined. Then, in accordance with the determined storage rule, the duplicates of the multiple blocks are stored in the identified multiple duplication destination storage media. By storing the duplicates in stripes like this, the uniform distributed storage processing described above can be realized. Of course, the “uniform” storage is not limited to storage in stripes.

The storage rule includes information indicating which block duplicate is to be stored in which duplication destination storage medium. In this case, the duplicates of the blocks specified by the storage rule may be stored in the identified multiple duplication destination storage media (111 to 113) in stages. Thereby, it is possible to perform storage of the duplicated blocks in stages according to the degree of concentration of accesses to particular contents (storage medium), and it is possible to improve the reading performance as necessary. Furthermore, since it is sufficient to store duplicated blocks in the minimum number of storage media at the initial stage, it is possible to maximally efficiently use the storage area when the whole storage system is considered.

In the present invention, the access frequency is detected by counting the number of accesses to each of the blocks stored in the multiple storage media. Multiple blocks for which the access frequency exceeds a predetermined value are caused to be a duplication source. Thereby, even when accesses are suddenly concentrated contrary to the initial expectation at the time of storing contents, or in the case where increase in access is not expected originally, the reading performance of a storage medium which stores the contents to which accesses have suddenly been concentrated does not suddenly deteriorate.

It is also possible to determine duplication destination storage media in ascending order of access frequency among the multiple storage media provided in the system. Thereby, it is possible to further distribute accesses to each storage medium.

Furthermore, it is also possible to generate duplicates of blocks corresponding to 50% or more of multiple blocks included in duplication source areas, and distribute and store the duplicates in duplication destination storage media. Thereby, as seen from the graphs of FIGS. 6 and 8, it is possible to assure higher reading performance than simple mirroring (FIG. 4). By generating duplicates of 50% of particular contents and storing the duplicates in duplication destination storage media initially, the reading performance can be improved quickly.

When duplicates are stored in duplication destination storage media, it is desirable to always generate a duplicate of the block of the top part and store the duplicate of the top block in a duplication destination storage medium. The reason is the following. The top part must be accessed first. Therefore, if the top part remains in the duplication source storage medium to which accesses have been concentrated and it is necessary to access the storage medium, the reading performance cannot be sufficiently improved.

On the other hand, when an access request (read request) for the block for which the duplicate storage processing has been performed, the read request is allocated not to the original block but to the duplicated block. Thereby, it is possible to distribute concentration of accesses to particular contents. However, if accesses are concentrated to a duplicate, then the reading performance of the duplication destination storage medium may deteriorate. Therefore, when there are multiple duplicated blocks, the access destination block is changed to a duplicated block on a storage medium with the least number of stored duplicated blocks related to the data. Alternatively, when there are already multiple duplicated blocks of a block to be accessed, the access destination block is changed to a duplicated block on a storage medium with the lowest access frequency. Thereby, it is possible to uniform (distribute) accesses between a duplication source storage medium and multiple duplication destination storage media.

In the present invention, each of the multiple storage media may be virtualized. When being virtualized, each storage medium is provided with a pool area in which original blocks are stored and a common area in which duplicated blocks are stored. Thereby, even in the case of a virtualization system operated with a capacity different from the actual physical capacity, areas for storing original data and duplicated data can be secured.

Processing for changing the area state (flag) of a pool area and a common area in a duplication source storage medium and a duplication destination storage medium to exchange a duplicated block and an original block may be performed. Thereby, it is possible to flexibly control the reading performance.

The present invention can also be realized by a program code of software for realizing the functions of the modes. In this case, a storage medium in which the program code is recorded is provided for a system or an apparatus, and the computer (or the CPU or the MPU) of the system or the apparatus reads the program code stored in the storage medium. In this case, the program code itself which has been read from the storage medium realizes the functions of the modes described before, and the program code itself and the storage medium storing it constitute the present invention. As the storage medium for providing the program code, for example, a flexible disk, CD-ROM, DVD-ROM, hard disk, optical disk, magneto-optical disk, CD-R, magnetic tape, non-volatile memory card and ROM are used.

It is also possible that an OS (operating system) or the like operating on a computer performs all or a part of the actual processing on the basis of instruction of the program code, and the functions of the modes described before are realized by the processing. Furthermore, it is also possible that, after the program code read from the storage medium is written in the memory on a computer, the CPU or the like of the computer performs all or a part of the actual processing on the basis of instructions of the program code, and the functions of the modes described before are realized by the processing.

Furthermore, it is also possible that the program code of the software for realizing the functions of the modes are distributed via a network so that it is stored in storage means, such as the hard disk or the memory of a system or an apparatus, or a storage medium such as a CD-RW and a CD-R, and the computer (or the CPU or the MPU) of the system or the apparatus reads and executes the program code stored in the storage means or the storage medium when it is used.

1. A storage system comprising:
multiple storage media (110 to 113) which are physically different from one another and each of which is configured by multiple blocks;
a duplication source area determination processing section (144) for determining duplication source areas (100 to 108) configured by multiple blocks which are to be duplication sources, among the multiple storage media, in response to a duplication start signal; and
a duplication processing section (144) for generating duplicates of the multiple blocks included in the duplication source areas, and distributing and storing the duplicates of the multiple blocks in the multiple storage media (duplication destination storage media (111 to 113)) other than the storage medium (110) including the duplication source areas (100 to 108).

2. The storage system according to claim 1, further comprising:
a duplication destination determination processing section (143) for identifying, on the basis of specified target performance and the performance of the multiple storage media, multiple duplication destination storage media which are to be storage destinations of the duplicates of the blocks and which are required to satisfy the target performance;
a storage rule determination processing section (144) for determining a storage rule for causing the duplicates of the multiple blocks to be distributed and stored in the identified duplication destination storage media (111 to 113) in stripes, which includes information indicating which block duplicate is to be stored in which duplication destination storage medium; and
an access frequency detection section (142) for counting the number of accesses to each of the blocks stored in the multiple storage media to detect the access frequency; wherein
the duplication source area determination processing section (144) determines the duplication source areas (100 to 108), with information about a block whose access frequency exceeds a predetermined access frequency, the information being received from the access frequency detection section, or duplication source area specification information from the outside as the duplication start signal; and
the duplication processing section (144) stores the duplicates of the blocks specified by the storage rule, into the identified multiple duplication destination storage media (111 to 113) in stages.

3. The storage system according to claim 1, further comprising:
a duplication destination determination processing section (143) for identifying, on the basis of specified target performance and the performance of the multiple storage media, multiple duplication destination storage media (111 to 113) which are to be storage destinations of the duplicates of the blocks and which are required to satisfy the target performance; and
a storage rule determination processing section (144) for determining a storage rule for causing the duplicates of the multiple blocks to be distributed and stored in the identified duplication destination storage media (111 to 113) in stripes; wherein
the duplication processing section (144) stores the duplicates of the multiple blocks into the identified multiple duplication destination storage media (111 to 113) in accordance with the determined storage rule.

4. The storage system according to claim 3, wherein
the storage rule includes information indicating which block duplicate is to be stored in which duplication destination storage medium; and
the duplication processing section (144) stores the duplicates of the blocks specified by the storage rule, into the identified multiple duplication destination storage media (111 to 113) in stages.

5. The storage system according to claim 3, further comprising:
an access frequency detection section (142) for counting the number of accesses to each of the blocks stored in the multiple storage media to detect the access frequency; wherein
the duplication source area determination processing section (144) determines the duplication source areas (100 to 108), with information about a block whose access frequency exceeds a predetermined access frequency, the information being received from the access frequency detection section (142), or duplication source area specification information from the outside as the duplication start signal.

6. The storage system according to claim 5, wherein the duplication destination determination processing section (143) determines the duplication destination storage media (111 to 113) in ascending order of the access frequency.

7. The storage system according to claim 1, wherein
the duplication processing section (144) generates duplicates of blocks corresponding to 50% or more of multiple blocks included in the duplication source areas (100 to 108), and distributes and stores the duplicates in the duplication destination storage media (111 to 113).

8. The storage system according to claim 1, wherein
in the case of generating duplicates of a part of the multiple blocks included in the duplication source areas (100 to 108), the duplication processing section (144) always generates a duplicate of the top part block (top block (100)) and stores the duplicate of the top block in the duplication destination storage medium.

9. The storage system according to claim 1, further comprising:
an access allocation processing section (145) for, when a request to access the block is a read request and there is a duplicate of the access target block, allocating the read request to the duplicated block.

10. The storage system according to claim 9, wherein
when the access request is a request to read data which is dividedly stored in multiple blocks and there are already multiple duplicates of a block to be the access destination, the access allocation processing section (145) changes the access destination block to a duplicated block in a storage medium having the least number of duplicated blocks related to the data.

11. The storage system according to claim 9, further comprising
an access frequency detection section (142) for counting the number of accesses to each of the blocks stored in the multiple storage media to detect the access frequency; wherein
when the access request is a request to read data which is dividedly stored in multiple blocks and there are already multiple duplicated blocks of a block to be the access destination, the access allocation processing section (145) changes the access destination block to a duplicated block in a storage medium with the lowest access frequency.

12. The storage system according to claim 1, wherein
the multiple storage media (110 to 113) have pool areas (410 to 413) each of which is virtualized and in which original blocks are stored and common areas (420 to 423) in which duplicated blocks are stored; and
the duplication processing section (144) stores the duplicates of the multiple blocks in the common areas (420 to 423) of the duplication destination storage media (111 to 113).

13. The storage system according to claim 12, further comprising:
a block state changing processing section (130) for changing the area state between the pool areas (410 to 413) and the common areas (420 to 423) in the duplication source storage medium (110) and the duplication destination storage media (111 to 113) to exchange a duplicated block and an original block.

14. A method for controlling a storage system, wherein
the storage system comprises: multiple storage media (110 to 113) which are physically different from one another and each of which is configured by multiple blocks; a duplication source area determination processing section (144) and a duplication processing section (144); and
the control method comprises the steps of:
the duplication source area determination processing section (144) determining duplication source areas (100 to 108) configured by multiple blocks which are to be duplication sources, among the multiple storage media (110 to 113), in response to a duplication start signal; and
the duplication processing section (144) generating duplicates of the multiple blocks included in the duplication source areas (100 to 108), and distributing and storing duplicates of the multiple blocks in the multiple storage media (duplication destination storage media (111 to 113)) other than the storage medium (110) including the duplication source areas.

15. The control method according to claim 14, wherein
the storage system further comprises a duplication destination determination processing section (143), a storage rule determination processing section (144) and an access frequency detection section (142); wherein
the control method further comprises the steps of:
the duplication destination determination processing section (143) identifying, on the basis of specified target performance and the performance of the multiple storage media, multiple duplication destination storage media (111 to 113) which are to be storage destinations of the duplicates of the blocks and which are required to satisfy the target performance;
the storage rule determination processing section (144) determining a storage rule for causing the duplicates of the multiple blocks to be distributed and stored in the identified duplication destination storage media (111 to 113) in stripes, which includes information indicating which block duplicate is to be stored in which duplication destination storage medium; and
the access frequency detection section (142) counting the number of accesses to each of the blocks stored in the multiple storage media (110 to 113) to detect the access frequency; wherein
at the step of determining the duplication source areas, the duplication source area determination processing section (144) determines the duplication source areas, with information about a block whose access frequency exceeds a predetermined access frequency, the information being received from the access frequency detection section (142), or duplication source area specification information from the outside as the duplication start signal; and
at the step of distributing and storing the duplicates of the multiple blocks, the duplication processing section (144) stores the duplicates of the blocks specified by the storage rule, into the identified multiple duplication destination storage media (111 to 113) in stages.
